(19) United States
(12) Patent Application Publication
(10) Pub. No.: US 2006/0065138 A1
(43) Pub. Date: Mar. 30, 2006

(54) Pad printing method for making colored contact lenses

(76) Inventors: Robert Carey Tucker, Suwanee, GA (US); Sandra Corti, Suwanne, GA (US); Michael Hugh Quinn, Suwanee, GA (US); Barry L. Atkins, Chicago, IL (US)

Correspondence Address: CIBA VISION CORPORATION;PATENT DEPARTMENT, 11460 JOHNS CREEK PARKWAY, DULUTH, GA, 30097-1556, US

(21) Appl. No.: 11/226,725

(22) Filed: Sep. 14, 2005

Related U.S. Application Data
(60) Provisional application No. 60/614,690, filed on Sep. 30, 2004.

(51) Int. Cl. B41F 17/00

(52) U.S. Cl. 101/41

(57) ABSTRACT

The invention provides a method for producing colored contact lenses with relatively high quality color images. The method of the invention comprises the steps of: (a) obtaining a water based ink having a viscosity of greater than about 100 centipoise (cps) and comprising at least one colorant, a water-soluble binder polymer having ethylenically unsaturated groups, an initiator, and a surfactant, wherein the surfactant is present in an amount sufficient to provide the ink a dynamic surface tension of less than about 40 dyne/cm at surface age of about 1 second, and wherein the initiator is present in an amount sufficient to allow the ink to be cured with an energy exposure which is comparable with an energy exposure required for curing the lens-forming material; (b) applying the ink, by using pad transfer printing technique, to at least a portion of at least one of molding surfaces of a lens mold to form a colored coat; (c) actinically curing the ink printed on the mold to form a colored film, wherein the printed ink is cured to an extent so that no noticeable color smearing is observed by examination with naked eyes; (d) dispensing a lens-forming material into the lens-forming cavity of the mold; and (e) actinically or thermally curing the lens-forming material within the lens-forming cavity to form the contact lens, whereby the colored film detaches from the molding surface and becomes integral with the body of the contact lens, wherein the colored film becomes part of one of the anterior and posterior surface of the colored contact lens and has a good adhesion to the lens.

This application claims the benefit under USC § 119 (e) of U.S. provisional application No. 60/614,690 filed Sep. 30, 2004, incorporated by reference in its entirety. Concurrently filed U.S. patent application Ser. No. (Attorney Docket No. CL/V-33975A/CVA) is also incorporated herein by reference in its entirety.

The present invention generally relates to a method for making colored contact lenses. More specifically, the present invention relates to a pad-printing method for making colored hydrogel contact lenses with good image quality.

### BACKGROUND

For cosmetic purposes, contact lenses having one or more colorants dispersed in the lens or printed on the lens are in high demand. These colored contact lenses enhance the natural beauty of the eye, or provide unique patterns on the iris of the wearer, or provide non cosmetic patterns or marks, such as rotation marks, inversion marks, product/brand codes, lot numbers, “DEMO” lenses, and the like, which are of benefits to wearers, eye-care practitioners and manufacturers.

Presently, pad printing has been used commercially for making colored contact lenses. A typical example of this printing follows. An image is etched into metal to form a cliché. The cliché is placed in a printer. Once in the printer, the cliché is inked with an ink by either an open inkwell doctoring system or by a closed ink cup sliding across the image. Then, a transfer-pad (also called a “tampon”), made of a material comprising silicone that can vary in elasticity, picks up the inked image from the cliché and transfers the image to a contact lens or a mold for making a contact lens. One of critical steps in the process involves accurately picking up the inked image from the cliché and not altering the design patterns of the image while it lays on the pad prior to transfer the inked image to the contact lens.

A number of inks are known in the art for cliché ink transfer printing of color images on a contact lens. Examples of such inks include those disclosed in U.S. Pat. Nos. 4,668,240, 4,857,072, 5,272,010, and 5,414,477 and U.S. patent application publication No. 2003/0054109 (all of which are incorporated herein by reference). The above inks are substantially similar in that they all are organic solvent-based inks which can effectively wet well the surface of a hydrophobic silicone pad. Advantages of using an organic solvent-based ink in a pad printing process are that an inked image can be easily picked up by a silicone pad from a cliché and that the design patterns of the inked image will not be altered while it lays on the pad prior to transfer the inked image to the contact lens.

It would be desirable to use a water-based ink in pad transfer printing since the water-based ink contain less volatile organic compounds and is more environmentally desirable. However, unlike an organic solvent-based ink, a water-based ink inherently has a high surface tension and poor wettability on a hydrophobic silicone pad. As such, it may be more difficult for a silicone pad to completely pick up an inked image from a cliché, and ink drops in the inked image may pool on a silicone pad, causing a loss of image quality and resolution.

Therefore, there exists a need for methods for producing a high-quality color image on a contact lens using a pad-printing system with water-based inks.

### SUMMARY OF THE INVENTION

The invention provides a method for making a colored hydrogel contact lens, comprising the steps of: (a) obtaining a water-based ink having a viscosity of greater than about 100 centipoise (cps) and comprising at least one colorant, a water-soluble binder polymer having ethylenically unsaturated groups, an initiator, and a surfactant, wherein the surfactant is present in an amount sufficient to provide the ink a dynamic surface tension of less than about 40 dyne/cm measured at surface age of about 1 second, wherein the initiator is present in an amount sufficient to allow the ink to be cured with an energy exposure which is comparable with an energy exposure required for curing the lens-forming material (b) applying the ink, by using pad transfer printing technique, to at least a portion of at least one of molding surfaces of a lens mold to form a colored coat; (c) actinically curing the ink printed on the mold to form a colored film, wherein the printed ink is cured to an extent so that no noticeable color smearing is observed by examination with naked eyes; (d) dispensing a hydrogel lens-forming material into the lens-forming cavity of the mold; and (e) actinically or thermally curing the lens-forming material within the lens-forming cavity to form the contact lens, whereby the colored film detaches from the molding surface and becomes integral with the body of the contact lens, wherein the colored film becomes part of one of the anterior and posterior surface of the colored contact lens and has a good adhesion to the lens.

### BRIEF DESCRIPTION OF THE DRAWING

FIG. 1 illustrates the images of black inks picked up by a conical silicone pad from a cliché.

FIG. 2 illustrates non-equilibrium surface tensions of two inks (1558-88-1 and 1558-85-3) as function of time, as determined by the pendant drop technique.

### DETAILED DESCRIPTION OF EMBODIMENTS OF THE INVENTION

Reference now will be made in detail to the embodiments of the invention. It will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well known and commonly employed in the art.

The invention is generally related to a method for making a colored hydrogel contact lens with relatively high precision and fidelity in reproducing a colored image design.

A “contact lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens. A contact lens can be in a dry state or a wet state. “Dry State” refers to a soft lens in a state prior to hydration or the state of a hard lens under storage or use conditions. “Wet State” refers to a soft lens in a hydrated state.

The “front or anterior surface” of a contact lens, as used herein, refers to the surface of the lens that faces away from the eye during wear. The anterior surface, which is typically substantially convex, may also be referred to as the front curve of the lens.

The “rear or posterior surface” of a contact lens, as used herein, refers to the surface of the lens that faces towards the eye during wear. The rear surface, which is typically substantially concave, may also be referred to as the base curve of the lens.

A “colored contact lens” refers to a contact lens (hard or soft) having a color image printed thereon. A color image can be a cosmetic pattern, for example, iris-like patterns, Wild Eye™ patterns, made-to-order (MTO) patterns, and the like; an inversion mark that allows a user to handle and insert easily a contact lens; a toric rotation mark, or contact lenses stock keeping units (SKUs), for example, either in forms of numbers or as bar codes. A color image can be a single color image or a multi-color image. A color image is preferably a digital image, but it can also be an analog image.

A colored contact lens can be produced by printing a high-quality color image directly on a contact lens using methods and systems of the invention. A contact lens can be clear before it is printed upon. Alternatively, a contact lens can be tinted prior to being printed upon. That is, a colorant may have been added to that lens using methods that are well known in the art before that lens is printed upon using a printing method of the invention.

A “colored coat” refers to a coating on an object and having a color image printed therein.

“Colorant” means either a dye or a pigment or a mixture thereof that is used to print a color image on an article.

“Dye” means a substance that is soluble in a solvent and that is used to impart color. Dyes are typically translucent and absorb but do not scatter light. Dyes can cover both optical regions of contact lenses and non-optical regions of contact lenses. Nearly any dye can be used in the present invention, so long as it can be used in an apparatus as described below.

A “pigment” means a powdered substance (particles) that is suspended in a liquid in which it is insoluble. Pigments are used to impart color. Pigments, in general, are more opaque than dyes.

The term “a conventional or non-pearlescent pigment” as used herein is intended to describe any absorption pigments that impart color based on the optical principle of diffuse scattering and its color is independent of its geometry. While any suitable non-pearlescent pigment may be employed, it is presently preferred that the non-pearlescent pigment is heat resistant, non-toxic and insoluble in aqueous solutions. Examples of preferred non-pearlescent pigments include any colorant permitted in medical devices and approved by the FDA, such as D&C Blue No. 6, D&C Green No. 6, D&C Violet No. 2, carbazole violet, certain copper complexes, certain chromium oxides, various iron oxides, phthalocyanine (PCN) green, phthalocyanine (PCN) blue, titanium dioxides, etc. See Marmiom D M Handbook of U.S. Colorants for a list of colorants that may be used with the present invention. A more preferred embodiment of a non-pearlescent pigment includes (C.I. is the color index no.), without limitation, for a blue color, phthalocyanine blue (pigment blue 15:3, C.I. 74160), cobalt blue (pigment blue 36, C. I. 77343), Toner cyan BG (Clariant), Permajet blue B2G (Clariant); for a green color, phthalocyanine green (Pigment green 7, C.I. 74260) and chromium sesquioxide; for yellow, red, brown and black colors, various iron oxides; PR122, PY154; for violet, carbazole violet; for black, Monolith black C-K (CIBA Specialty Chemicals).

“Pearlescence” means having a pearly luster; resembling a pearl in physical appearance; or having a nearly neutral slightly bluish medium gray color.

A “pearlescent pigment” refers to a class of interference (effect) pigments, which are transparent thin platelets of low refractive index material (e.g., transparent mica platelets) coated with optically thin coating of a high refractive index material (e.g., metal oxide, such as, for example titanium oxide or iron oxide), and which impart color mainly based on the optical principle of thin-film interference. The optically thin coating of metal oxide can be comprised of single or multiple thin layers of metal oxide. Optically thin coatings applied to the platelets contribute interference effects, which allow the appearance to vary depending upon illumination and viewing conditions. The color is determined by the coating thickness, the refractive index and the angle of illumination. Optically thin coatings are also responsible for the rich deep glossy effect due to partial reflection from and partial transmission through the mica platelets. This class of pigment can provide pearly luster and iridescent effects.

Pearlescent pigments which are mica platelets with an oxide coating are commercially available from by the Englehard Corp. of Iselin, N.J., under the “Mearlin Pigment” line, such as “Hi-Lite Interference Colors,” “Dynacolor Pearlescent Pigments”, “MagnaPearl”, “Flamenco,” and “Celini Colors.” Additional manufacturers of pearlescent colorants are: Kemira, Inc. in Savannah, Ga., the pigments having the trade name “Flonac Lustre Colors”; and EM Industries, Inc. of Hawthorne, N.Y., the pigments having the trade name “Affair Lustre Pigments”.

In the case of pearlescent pigments, it is important during processing to minimize platelet breakage and maintain a sufficient level of dispersion. Pearlescent pigments require gentle handling during mixing and they should not be ground, or subjected to prolonged mixing, milling or high shear since such operations can damage the pigments. Particle size distribution, shape and orientation strongly influence final appearance. Milling, high shear mixing or prolonged processing of pearlescent pigments should be avoided since such operations might lead to delamination of metal oxide coated layer, fragmentation of platelets, platelet agglomeration and platelet compaction. Delamination of metal oxide, compaction, fragmentation and agglomeration will reduce pearlescent effects.

The term “ethylenically unsaturated group” or “olefinically unsaturated group” is employed herein in a broad sense and is intended to encompass any groups containing at least one >C═C< group. Exemplary ethylenically unsaturated groups include without limitation acryloyl, methacryloyl, allyl, vinyl, styrenyl, or other C═C containing groups.

A “hydrogel” refers to a polymeric material which can absorb at least 10 percent by weight of water when it is fully hydrated. Generally, a hydrogel material is obtained by polymerization or copolymerization of at least one hydrophilic monomer in the presence of or in the absence of additional monomers and/or macromers.

A “HEMA-based hydrogel” refers to a hydrogel obtained by copolymerization of a polymerizable composition comprising HEMA.

A “silicone hydrogel” refers to a hydrogel obtained by copolymerization of a polymerizable composition comprising at least one silicone-containing monomer or at least one silicone-containing macromer.

“Hydrophilic,” as used herein, describes a material or portion thereof that will more readily associate with water than with lipids.

“Ophthalmically compatible”, as used herein, refers to a material or surface of a material which may be in intimate contact with the ocular environment for an extended period of time without significantly damaging the ocular environment and without significant user discomfort.

“Ocular environment”, as used herein, refers to ocular fluids (e.g., tear fluid) and ocular tissue (e.g., the cornea) and/or conjunctiva which may come into intimate contact with a contact lens.

A “lens-forming material” refers to a polymerizable composition which can be cured (i.e., polymerized and/or crosslinked) thermally or actinically to obtain a crosslinked polymer. As used herein, “actinically” in reference to curing or polymerizing of a polymerizable composition or material or a lens-forming material means that the curing (e.g., crosslinked and/or polymerized) is performed by actinic irradiation, such as, for example, UV irradiation, ionized radiation (e.g. gamma ray or X-ray irradiation), microwave irradiation, and the like. Thermal curing or actinic curing methods are well-known to a person skilled in the art. Lens-forming materials are well known to a person skilled in the art. Typically, a lens-forming material is a solution or a solvent-free liquid or melt of one or more prepolymers, one or more vinylic monomers, and/or one or more macromers optionally in the presence of various other components, e.g., such as, photoinitiator, inhibitors, fillers, and the like.

A “prepolymer” refers to a starting polymer which can be cured (e.g., crosslinked and/or polymerized) actinically or thermally or chemically to obtain a crosslinked and/or polymerized polymer having a molecular weight much higher than the starting polymer. A “crosslinkable prepolymer” refers to a starting polymer which can be crosslinked upon actinic radiation to obtain a crosslinked polymer having a molecular weight much higher than the starting polymer.

A “monomer” means a low molecular weight compound that can be polymerized. Low molecular weight typically means average molecular weights less than 700 Daltons.

A “vinylic monomer”, as used herein, refers to a low molecular weight compound that has an ethylenically unsaturated group and can be polymerized actinically or thermally. Low molecular weight typically means average molecular weights less than 700 Daltons.

A “hydrophilic vinylic monomer”, as used herein, refers to a vinylic monomer which as a homopolymer typically yields a polymer that is water-soluble or can absorb at least 10 percent by weight water. Suitable hydrophilic monomers are, without this being an exhaustive list, hydroxyl-substituted lower alkyl (C₁ to C₈) acrylates and methacrylates, acrylamide, methacrylamide, (lower allyl)acrylamides and -methacrylamides, ethoxylated acrylates and methacrylates, hydroxyl-substituted (lower alkyl)acrylamides and -methacrylamides, hydroxyl-substituted lower alkyl vinyl ethers, sodium vinylsulfonate, sodium styrenesulfonate, 2-acrylamido-2-methylpropanesulfonic acid, N-vinylpyrrole, N-vinyl-2-pyrrolidone, 2-vinyloxazoline, 2-vinyl-4,4′-dialkyloxazolin-5-one, 2- and 4-vinylpyridine, vinylically unsaturated carboxylic acids having a total of 3 to 5 carbon atoms, amino(lower alkyl)—(where the term “amino” also includes quaternary ammonium), mono(lower alkylamino)(lower alkyl) and di(lower alkylamino)(lower alkyl)acrylates and methacrylates, allyl alcohol and the like.

A “hydrophobic vinylic monomer”, as used herein, refers to a vinylic monomer which as a homopolymer typically yields a polymer that is insoluble in water and can absorb less than 10 percent by weight water.

A “macromer” refers to a medium and high molecular weight compound or polymer that contains functional groups capable of undergoing further polymerizing/crosslinking reactions. Medium and high molecular weight typically means average molecular weights greater than 700 Daltons. Preferably, a macromer contains ethylenically unsaturated groups and can be polymerized actinically or thermally.

A “polymer” means a material formed by polymerizing/crosslinking one or more monomers.

A “photoinitiator” refers to a chemical that initiates radical crosslinking/polymerizing reaction by the use of light. Suitable photoinitiators include, without limitation, benzoin methyl ether, diethoxyacetophenone, a benzoylphosphine oxide, 1-hydroxycyclohexyl phenyl ketone, Darocure® types, and Irgacure® types, preferably Darocure® 1173, and Irgacure® 2959.

A “thermal initiator” refers to a chemical that initiates radical crosslinking/polymerizing reaction by the use of heat energy. Examples of suitable thermal initiators include, but are not limited to, 2,2′-azobis(2,4-dimethylpentanenitrile), 2,2′-azobis(2-methylpropanenitrile), 2,2′-azobis(2-methylbutanenitrile), peroxides such as benzoyl peroxide, and the like. Preferably, the thermal initiator is 2,2′-azobis(isobutyronitrile) (AIBN).

An “interpenetrating polymer network (IPN)” as used herein refers broadly to an intimate network of two or more polymers at least one of which is either synthesized and/or crosslinked in the presence of the other(s). Techniques for preparing IPN are known to one skilled in the art. For a general procedure, see U.S. Pat. Nos. 4,536,554, 4,983,702, 5,087,392, and 5,656,210, the contents of which are all incorporated herein by reference. The polymerization is generally carried out at temperatures ranging from about room temperature to about 145° C.

“A binder polymer” refers to a crosslinkable polymer that can be crosslinked by a crosslinker or upon initiation by a chemical or physical means (e.g., moisture, heating, UV irradiation or the like) to trap or bind colorants onto or into a contact lens such as that term is known in the art.

As used herein, “good adhesion to a contact lens” in reference to a colored coat or film or an ink means that the colored coat or film (with a color image) generated on the lens with the ink can pass a sterilization-surviving test and at least a finger rubbing test, preferably further pass a sonication-in-methanol (or other suitable solvent, e.g., such as isopropanol) surviving test.

The finger rubbing test is performed by removing the hydrated contact lens from a packaging solution, e.g., saline, and digitally rubbing the lens between either two fingers or a finger and a palm for up to about 10 seconds. Visible and microscopic (˜10×) observation of colorant bleeding, smearing, or delamination indicates failure of the rub test.

The sonication-in-methanol (or other suitable solvent, e.g., such as isopropanol) test is performed as follows. A colored contact lens is immersed in 5 ml of, for example, methanol or isopropanol or a suitable solvent, sonicated for about 1 minute and then placed in a vial containing borate buffered saline (BBS). After about 10 seconds, the saline is drained and about 5 ml of fresh BBS is added. After equilibrating for about 5 minutes in the BBS, the lens is inspected for signs of adhesion failure (e.g., colorant bleeding, smearing, or delamination).

“Passing a sterilization-surviving test” means that no significant decoloring or delamination or the like can be observed after sterilization. Production of contact lenses always involve a step of sterilization, such as autoclave, or irradiation with UV light, x-ray, or the like. For example, an autoclave-surviving test can be performed by removing a sterilized contact lens from a packaging solution, e.g., saline, and immersing it into a vial of methanol. The vial containing the hydrated contact lens and methanol is sonicated for 30 seconds using a standard laboratory sonicator. The lens is then removed from the methanol and placed back into the packaging solution. A finger rubbing test is performed on this lens. Observation of bleeding, smearing, or delamination indicates failure of this test.

A “print-on-mold process for producing colored contact lenses” refers to a process for molding a colored contact lens described in U.S. Pat. No. 5,034,166 to Rawlings et al. (herein incorporated by reference).

A “good transferability from a mold to a contact lens” in reference to an ink or a colored coat means that a color image printed on a molding surface of a mold with the ink can be transferred completely onto a contact lens cured (thermally or actinically) in that mold.

“Surface age” as used herein refers to the amount of time which is allowed for surfactant molecules in a water-based ink to migrate (diffuse) to any newly formed interface (ink/air) during a dynamic (non-equilibrium) surface tension measuring process.

The term “surfactant,” as used herein, refers to a surface-active compound as that term is well known in the art.

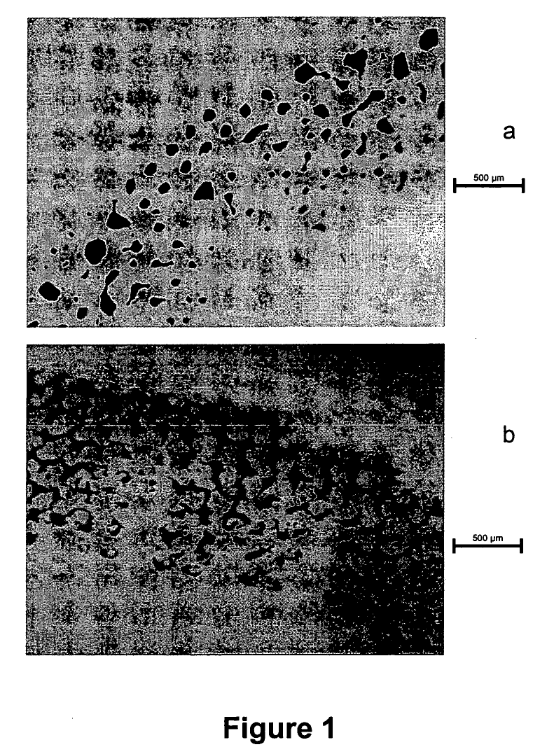

A “spatial limitation of actinic radiation” refers to an act or process in which energy radiation in the form of rays is directed by means of, for example, a mask or screen or combinations thereof, to impinge, in a spatially restricted manner, onto an area having a well defined peripheral boundary. For example, a spatial limitation of UV radiation can be achieved by using a mask or screen which has a transparent or open region (unmasked region) surrounded by a UV impermeable region (masked region), as schematically illustrated in FIGS. 1-9 of U.S. Pat. No. 6,627,124 (herein incorporated by reference in its entirety). The unmasked region has a well defined peripheral boundary with the unmasked region.

The invention provides a method for producing colored contact lenses with relatively high quality color images. The method of the invention comprises the steps of: (a) obtaining a water based ink having a viscosity of greater than about 100 centipoise (cps) and comprising at least one colorant, a water-soluble binder polymer having ethylenically unsaturated groups, an initiator, and a surfactant, wherein the surfactant is present in an amount sufficient to provide the ink a dynamic surface tension of less than about 40 dyne/cm at surface age of about 1 second; (b) applying the ink, by using pad transfer printing technique, to at least a portion of at least one of molding surfaces of a lens mold to form a colored coat; (c) actinically curing the ink printed on the mold to form a colored film, wherein the printed ink is cured to an extent so that no noticeable color smearing is observed by examination with naked eyes; (d) dispensing a lens-forming material into the lens-forming cavity of the mold; and (e) actinically or thermally curing the lens-forming material within the lens-forming cavity to form the contact lens, whereby the colored film detaches from the molding surface and becomes integral with the body of the contact lens, wherein the colored film becomes part of one of the anterior and posterior surface of the colored contact lens and has a good adhesion to the lens.

In accordance with the invention, a water-based ink is an ink in which solvent is water. The ink may also (but preferably do not) comprise an organic solvent in addition to water. Any known suitable organic solvents can be used, so long as they do not precipitate the binder polymer, or adversely affect the stability of the colorant. Exemplary organic solvents include, without limitation, alcohols (e.g., methanol, ethanol, propanol, isopropanol, cyclohexanol, 1-butanol etc.), glycols (e.g. ethylene glycol, ethylene glycol monoethyl ether, ethylene glycol monobutyl ether, ethylene glycol monomethyl ether, diethylene glycol, propylene glycol, etc.), ketones (e.g. acetone, cyclopentanone, cyclohexanone, acetophenone, diacetone alcohol, methyl ethyl ketone, methyl isobutyl ketone,), esters (butyl acetate, ethyl acetate, gamma-butyrolactone, etc.), tetrahydrofuran, methyl-2-pyrrolidone, dimethyl formamide, dimethyl sulfoxide, isophorone, propylene carbonate, 1,4-dioxane, nitromethane, ethanolamine, acetonitrile, acetic acid, formaldhehyde and formamide.

In accordance with the present invention, a binder polymer preferably is a water-soluble, actinically crosslinkable prepolymer which is one of polymerizable components in a lens-forming material for making colored contact lenses. It is understood that a binder polymer can be an actinically crosslinkable prepolymer which is soluble in a mixture of water with one or more organic solvents.

Examples of preferred actinically crosslinkable prepolymers include, but are not limited to, a water-soluble crosslinkable poly(vinyl alcohol) prepolymer described in U.S. Pat. Nos. 5,583,163 and 6,303,687 (incorporated by reference in their entireties); a water-soluble vinyl group-terminated polyurethane which is obtained by reacting an isocyanate-capped polyurethane with an ethylenically unsaturated amine (primary or secondary amine) or an ethylenically unsaturated monohydroxy compound, wherein the isocyanate-capped polyurethane can be a copolymerization product of at least one polyalkylene glycol, a compound containing at least 2 hydroxyl groups, and at least one compound with two or more isocyanate groups; derivatives of a polyvinyl alcohol, polyethyleneimine or polyvinylamine, which are disclosed in U.S. Pat. No. 5,849,841 (incorporated by reference in its entirety); a water-soluble crosslinkable polyurea prepolymer described in U.S. Pat. No.6,479,587 (herein incorporated by reference in its entirety); crosslinkable polyacrylamide; crosslinkable statistical copolymers of vinyl lactam, MMA and a comonomer, which are disclosed in EP 655,470 and U.S. Pat. No. 5,712,356; crosslinkable copolymers of vinyl lactam, vinyl acetate and vinyl alcohol, which are disclosed in EP 712,867 and U.S. Pat. No. 5,665,840; polyether-polyester copolymers with crosslinkable side chains which are disclosed in EP 932,635; branched polyalkylene glycol-urethane prepolymers disclosed in EP 958,315 and U.S. Pat. No. 6,165,408; polyalkylene glycol-tetra(meth)acrylate prepolymers disclosed in EP 961,941 and U.S. Pat. No. 6,221,303; and crosslinkable polyallylamine gluconolactone prepolymers disclosed in PCT patent application WO 2000/31150.

In a preferred embodiment, a binder polymer is a water-soluble crosslinkable poly(vinyl alcohol) prepolymer. More preferably, a water-soluble crosslinkable poly(vinyl alcohol) prepolymer is a polyhydroxyl compound which is described in U.S. Pat. Nos. 5,583,163 and 6,303,687 and has a molecular weight of at least about 2000 and which comprises from about 0.5 to about 80%, based on the number of hydroxyl groups in the poly(vinyl alcohol), of units of the formula I, I and II, I and III, or I and II and III

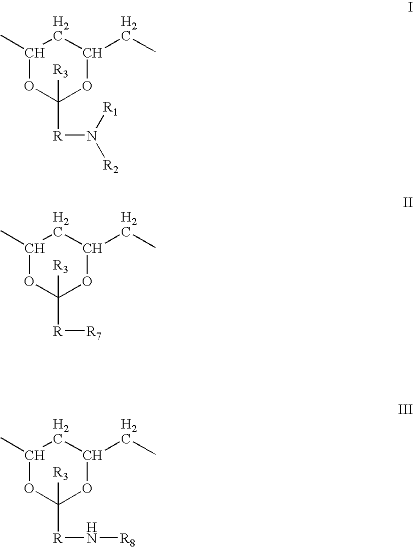

In formula I, II and III, the molecular weight refers to a weight average molecular weight, Mw, determined by gel permeation chromatography.

In formula I, II and III, R₃ is hydrogen, a C₁-C₆ alkyl group or a cycloalkyl group.

In formula I, II and III, R is alkylene having up to 12 carbon atoms, preferably up to 8 carbon atoms, and can be linear or branched. Suitable examples include octylene, hexylene, pentylene, butylene, propylene, ethylene, methylene, 2-propylene, 2-butylene and 3-pentylene. Lower alkylene R preferably has up to 6, particularly preferably up to 4 carbon atoms. Methylene and butylene are particularly preferred.

In the formula I, R₁ is hydrogen or lower alkyl having up to seven, in particular up to four, carbon atoms. Most preferably, R₁ is hydrogen.

In the formula I, R₂ is an olefinically unsaturated, electron-withdrawing, crosslinkable radical, preferably having up to 25 carbon atoms. In one embodiment, R₂ is an olefinically unsaturated acyl radical of the formula R₄—CO—, in which R₄ is an olefinically unsaturated, crosslinkable radical having 2 to 24 carbon atoms, preferably having 2 to 8 carbon atoms, particularly preferably having 2 to 4 carbon atoms.

The olefinically unsaturated, crosslinkable radical R₄ having 2 to 24 carbon atoms is preferably alkenyl having 2 to 24 carbon atoms, in particular alkenyl having 2 to 8 carbon atoms, particularly preferably alkenyl having 2 to 4 carbon atoms, for example ethenyl, 2-propenyl, 3-propenyl, 2-butenyl, hexenyl, octenyl or dodecenyl. Ethenyl and 2-propenyl are preferred, so that the —CO—R₄ group is the acyl radical of acrylic acid or methacrylic acid.

In the formula II, R₇ is a primary, secondary or tertiary amino group or a quaternary amino group of the formula N⁺(R′)₃X⁻, in which each R′, independently of the others, is hydrogen or a C₁-C₄ alkyl radical and X is a counterion, for example HSO₄⁻, F⁻, Cl⁻, Br⁻, I⁻, CH₃COO⁻, OH⁻, BF⁻, or H₂PO₄⁻. The radicals R₇ are, in particular, amino, mono- or di(lower alkyl)amino, mono- or diphenylamino, (lower alkyl)phenylamino or tertiary amino incorporated into a heterocyclic ring, for example —NH₂, —NH—CH₃, —N(CH₃)₂, —NH(C₂H₅), —N(C₂H₅)₂, —NH(phenyl), —N(C₂H₅)phenyl or

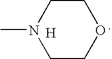

In the formula III, R₈ is the radical of a monobasic, dibasic or tribasic, saturated or unsaturated, aliphatic or aromatic organic acid or sulfonic acid. Preferred radicals R₈ are derived, for example, from chloroacetic acid, succinic acid, glutaric acid, adipic acid, pimelic acid, maleic acid, fumaric acid, itaconic acid, citraconic acid, acrylic acid, methacrylic acid, phthalic acid and trimellitic acid.

For the purposes of this invention, the term “lower” in connection with radicals and compounds denotes, unless defined otherwise, radicals or compounds having up to 7 carbon atoms, preferably having up to 4 carbon atoms.

Lower alkyl has, in particular, up to 7 carbon atoms, preferably up to 4 carbon atoms, and is, for example, methyl, ethyl, propyl, butyl or tert-butyl.

Lower alkoxy has, in particular, up to 7 carbon atoms, preferably up to 4 carbon atoms, and is, for example, methoxy, ethoxy, propoxy, butoxy or tert-butoxy.

In the formula N⁺(R′)₃X⁻, R′ is preferably hydrogen or C₁-C₃ alkyl, and X is halide, acetate or phosphite, for example —N⁺(C₂H₅)₃CH₃COO⁻, —N⁺(C₂H₅)₃Cl⁻, and —N⁺(C₂H₅)₃H₂PO₄⁻.

A water-soluble crosslinkable poly(vinyl alcohol) according to the invention is more preferably a polyhydroxyl compound which has a molecular weight of at least about 2000 and which comprises from about 0.5 to about 80%, preferably from 1 to 50%, more preferably from 1 to 25%, even more preferably from 2 to 15%, based on the number of hydroxyl groups in the poly(vinyl alcohol), of units of the formula I, wherein R is lower alkylene having up to 6 carbon atoms, R₁ is hydrogen or lower alkyl, R₃ is hydrogen, and R₂ is a radical of formula (V). Where p is zero, R₄ is preferably C₂-C₈ alkenyl. Where p is one and q is zero, R₆ is preferably C₂-C₆ alkylene and R₄ is preferably C₂-C₈ alkenyl. Where both p and q are one, R₅ is preferably C₂-C₆ alkylene, phenylene, unsubstituted or lower alkyl-substituted cyclohexylene or cyclo hexylene-lower alkylene, unsubstituted or lower alkyl-substituted phenylene-lower alkylene, lower alkylene-phenylene, or phenylene-lower alkylene-phenylene, R₆ is preferably C₂-C₆ alkylene, and R₄ is preferably C₂-C₈ alkenyl.

Crosslinkable poly(vinyl alcohol)s comprising units of the formula I, I and II, I and III, or I and II and III can be prepared in a manner known per se. For example, U.S. Pat. Nos. 5,583,163 and 6,303,687 disclose and teach how to prepare crosslinkable polymers comprising units of the formula I, I and II, I and III, or I and II and III.

In another preferred embodiment, a binder polymer is s a crosslinkable polyurea prepolymer as described in U.S. Pat. No. 6,479,587 or in a commonly assigned copending U.S. patent application 60/ filed 2003 (herein incorporated by reference in their entireties)

A preferred crosslinkable polyurea prepolymer has formula (1)
CP-(Q)_{q} (1)
wherein q is an integer of ≧3, Q is an organic radical that comprises at least one crosslinkable group, CP is a multivalent branched copolymer fragment comprising segments A and U and optionally segments B and T, wherein: A is a bivalent radical of formula
—NR_{A}-A₁-NR_{A}′— (2),
wherein A₁ is the bivalent radical of —(R₁₁—O)ₙ—(R₁₂—O)ₘ—(R₁₃—O)ₚ—, a linear or branched C₂-C₂₄ aliphatic bivalent radical, a C₅-C₂₄ cycloaliphatic or aliphatic-cycloaliphatic bivalent radical, or a C₆-C₂₄ aromatic or araliphatic bivalent radical, R₁₁, R₁₂, R₁₃, independently of one other, are each linear or branched C₂-C₄-alkylene or hydroxy-substituted C₂-C₈ alkylene radical, n, m and p, independently of one another, are each a number from 0 to 100, provided that the sum of (n+m+p) is 5 to 1000, and R_{A} and R_{A}′ independently of each other is hydrogen, an unsubstituted C₁-C₆alkyl, a substituted C₁-C₆alkyl, or a direct, ring-forming bond;
T is a bivalent radical of formula 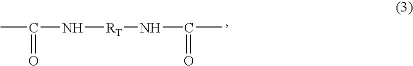
wherein R_{T} is a bivalent aliphatic, cycloaliphatic, aliphatic-cycloaliphatic, aromatic, araliphatic or aliphatic-heterocyclic radical;
U is a trivalent radical of formula 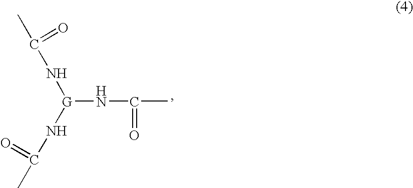
wherein G is a linear or branched C₃-C₂₄ aliphatic trivalent radical, a C₅-C₄₅ cycloaliphatic or aliphatic-cycloaliphatic trivalent radical, or a C₃-C₂₄ aromatic or araliphatic trivalent radical;
B is a radical of formula
   —NR_{B}—B₁—NR_{B}′— (5),
wherein R_{B} and R_{B}′ independently of each other is hydrogen, an unsubstituted C₁-C₆alkyl, a substituted C₁-C₆alkyl, or a direct, ring-forming bond, B₁ is a bivalent aliphatic, cycloaliphatic, aliphatic-cycloaliphatic, aromatic or araliphatic hydrocarbon radical that has at least one primary or secondary amine group or is interrupted by at least one amine group —NRₘ— in which Rₘ is hydrogen, a radical Q mentioned above or a radical of formula
   Q-CP′— (6),
wherein Q is as defined above, and CP′ is a bivalent copolymer fragment comprising at least two of the above-mentioned segments A, B, T and U; provided that in the copolymer fragments CP and CP′ a segment A or B is followed by a segment T or U in each case; provided that in the copolymer fragments CP and CP′ a segment T or U is followed by a segment A or B in each case; provided that the radical Q in formulae (1) and (6) is bonded to a segment A or B in each case; and provided that the N atom of —NRₘ— is bonded to a segment T or U when Rₘ is a radical of formula (6).

A crosslinkable prepolymer of formula (1) is obtained by introducing ethylenically unsaturated groups into an amine- or isocyanate-capped polyurea, which preferably is a copolymerization product of a mixture comprising (a) at least one poly(oxyalkylene)diamine, (b) at least one organic poly-amine, (c) optionally at least one diisocyanate, and (d) at least one polyisocyanate. More preferably, the amine- or isocyanate-capped polyurea is a copolymerization product of a mixture comprising (a) at least one poly(oxyalkylene)diamine, (b) at least one organic di- or poly-amine (preferably triamine), (c) at least one diisocyanate, and (d) at least one polyisocyanate (preferably triisocyanate).

Examples of preferred poly(oxyalkylene)diamine include so-called Jeffamines® having an average molecular weight of, for example, approximately from 200 to 5000.

Diisocyanate can be a linear or branched C₃-C₂₄ aliphatic diisocyanate, a C₅-C₂₄ cycloaliphatic or aliphatic-cycloaliphatic diisocyanate, or a C₆-C₂₄ aromatic or araliphatic diisocyanate. Examples of especially preferred diisocyanates are isophorone diisocyanate (IPDI), 4,4′-methylenebis(cyclohexyl isocyanate), toluylene-2,4-diisocyanate (TDI), 1,6-diisocyanato-2,2,4-trimethyl-n-hexane (TMDI), methylenebis(cyclohexyl-4-isocyanate), methylenebis(phenyl-isocyanate) or hexamethylene-diisocyanate (HMDI).

An organic diamine can be a linear or branched C₂-C₂₄ aliphatic diamine, a C₅-C₂₄ cycloaliphatic or aliphatic-cycloaliphatic diamine, or a C₆-C₂₄ aromatic or araliphatic diamine. A preferred organic diamine is bis(hydroxyethylene)ethylenediamine (BHEEDA).

Examples of preferred polyamines are symmetrical or asymmetrical dialkylenetriamines or trialkylenetetramines. Preferred polyamines include without limitation diethylenetriamine, N-2′-aminoethyl-1,3-propylenediamine, N,N-bis(3-aminopropyl)-amine, N,N-bis(6-aminohexyl)amine and triethylenetetramine.

A polyisocyanate can be a linear or branched C₃-C₂₄ aliphatic polyisocyanate, a C₅-C₄₅ cycloaliphatic or aliphatic-cycloaliphatic polyisocyanate, or a C₆-C₂₄ aromatic or araliphatic polyisocyanate. Preferably, a polyisocyanate is a C₆-C₄₅ cycloaliphatic or aliphatic-cycloaliphatic compound containing 3-6 isocyanate groups and at least one heteroatom selected from the group consisting of oxygen and nitrogen. More preferably, a polyisocyanate is a compound having a group of formula (7): 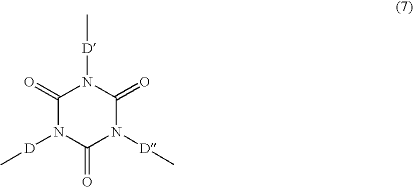
wherein D, D′ and D″ independent of one another are a linear or branched divalent C₁-C₁₂ alkyl radical, a divalent C₅-C₁₄ alkylcycloalkyl radical. Examples of preferred triisocyanates include without limitation the isocyanurate trimer of hexamethylene diisocyanate, 2,4,6-toluene triisocyanate, p, p′, p″-triphenylmethane triisocyanate, and the trifunctional trimer (isocyanurate) of isophorone diisocyanate.

It is advantageous that the amine- or isocyanate-capped polyurea is an amine-capped polyurea which may allow the second step reaction to be carried out in an aqueous medium.

A crosslinkable polyurea prepolymer of the invention can be prepared in a manner known to person skilled in the art, for example in a two-step process. In the first step, an amine- or isocyanate-capped polyurea of the invention is prepared by reacting together a mixture comprising (a) at least one poly(oxyalkylene)diamine, (b) at least one organic di- or poly-amine, (c) at least one diisocyanate, and (d) at least one polyisocyanate. In the second step, a multifunctional compound having at least one ethylenically unsaturated group and a function group coreactive with the capping amine or isocyanate groups of the amine- or isocyanate-capped polyurea obtained in the first step.

The first step reaction is advantageously carried out in an aqueous or aqueous-organic medium or organic solvent (e.g, ethyllactate, THF, isopropanol, or the like). A suitable medium has been found to be especially a mixture of water and a readily water-soluble organic solvent, e.g. an alkanol, such as methanol, ethanol or isopropanol, a cyclic ether, such as tetrahydrofuran (THF), or a ketone, such as acetone. An especially suitable reaction medium is a mixture of water and a readily water-soluble solvent having a boiling point of from 50 to 85° C., preferably from 50 to 70° C., especially a water/tetrahydrofuran or a water/acetone mixture.

The reaction temperature in the first reaction step of the process is, for example, from −20 to 85° C., preferably from −10 to 50° C. and most preferably from −5 to 30° C.

The reaction times in the first reaction step of the process may vary within wide limits, a time of approximately from 1 to 10 hours, preferably from 2 to 8 hours and most preferably 2 to 3 hours having proved practicable.

Dyes may not provide a highly opaque print that pigment can provide. Accordingly, a colorant in an ink of the invention comprises preferably at least one pigment. A colorant also may be a mixture of two or more pigments, which in combination provides a desired color, since any color can be obtained by merely mixing two or more primary colors together, As defined herein, “primary colors” mean cyan, yellow, magenta, white, and black. A colorant may also be a mixture of at least one pigment and at least one dye. A person skill in the art will know how to select colorants.

The choice of pigments is quite flexible, since they need not necessarily contain functional groups. The pigments may be any coloring substance or combination thereof that provides a desired color. Preferred pigments include (C.I. is the color index no.) for a blue color, phthalocyanine blue (pigment blue 15, C.I. 74160), cobalt blue (pigment blue 36, C.I. 77343); for a green color, phthalocyanine green (Pigment green 7, C.I. 74260) and chromium sesquioxide; for yellow, red, brown and black colors, various iron oxides; for violet, carbazole violet. Of course, since any color can be obtained by merely mixing two or more primary colors together, blends of such primary colors are used to achieve the desired shade. Titanium dioxide can be added to the ink to increase the opacity of the pattern.

Pigment(s) are preferably about 5 microns or smaller in size. Larger particles of a pigment can be ground into smaller particles. Any number of methods known in the art can be used to grind pigment. Exemplary preferred methods of reducing a pigment's particle size include high speed mixers, Kady Mills (rotor stator dispersion device), colloid mills, homogenizers, microfluidizers, sonalators, ultrasonic mills, roll mills, ball mills, roller mills, vibrating ball mills, attritors, sand mills, varikinetic dispensers, three-roll mills, Banbury mixers, or other methods well known to those of skill in the art.

In accordance with the present invention, a surfactant added in an ink of the invention preferably has a rapid diffusive characteristics and is capable of reducing surface tension under highly dynamic conditions, such as met in pad-transfer printing with a water-based ink. Pad-transfer printing involves picking up inks by a silicone pad from a cliché and then transferring the picked up inks from the pad to a receiving surface of an article (e.g., a molding surface of a mold for making a contact lens) within a limited time period (e.g., less than 10 second). During the step of picking up inks by a pad from a cliché, new ink/pad interface and ink/air interface are created and it takes a finite amount of time for the surfactant molecules to diffuse to and adsorb at the newly created ink/pad interface and the ink/air interface and thereby for the surface tension to reach equilibrium. Since the step of picking up inks by a pad from a cliché is typically accomplished within a finite amount of time (e.g., a few seconds), there is no enough time for establishing the thermodynamic equilibrium between the surface layer and bulk ink. It is discovered that, when a rapid diffusive surfactant present in a water-based ink in an amount sufficient to provide the ink a dynamic surface tension of less than about 40 mN/m, preferably less than about 38 mN/m, more preferably less than about 35 mN/m, at a surface age of about 1 second, a silicone pad can easily and completely pick up an inked image from a cliché and one can prevent ink drops in the inked image from pooling on the silicone pad, thereby reproducing the designed colored image with relatively high quality and resolution.

Examples of preferred rapid diffusive surfactants are acetylenic diol-based surfactants. Preferably, a surfactant in a water-based ink of the invention is Surfynol® 420 surfactant (ethoxylated acetylenic diols). The concentration of Surfynol® 420 surfactant in an ink of the invention is preferably from about 0.03% to about 0.16% by weight. It is also found that lower surfactant concentration seems to provide to a resultant colored contact lens an increased color intensity. It is believed that such increased color intensity could be due to that the ink spreads less on the silicone pad.

Static (also known as equilibrium) surface tension and dynamic surface tension can be measured according to any well known methods. For example, static surface tension can be measured according to the DuNouy Ring Method or the Wilhelmy plate method. Dynamic surface tension can be measured according to any known methods, for example, by the pendant drop technique as described in Examples, or by using SensaDyne Tensiometers.

In accordance with the invention, an ink of the invention preferably comprise an initiator, preferably a photoinitiator, in an amount sufficient to allow the ink to be cured with an energy exposure which is comparable with an energy exposure required for curing a lens-forming material to be used for making lenses. Preferably, the energy exposure required for curing the ink is about 0.2 to 5 folds, preferably 0.5-2 folds, of an energy exposure required for curing the lens-forming material to be used.

Energy exposure (E) is defined as the amount of energy striking a surface and measured in term of energy/area aoules/cm²). A fluid composition generally needs to be subjected to a minimal energy exposure to cause a sufficient amount of initiator to form free radicals, thereby causing vinyl groups in the monomer/prepolymer to crosslink,and/or polymerize. Determination of energy exposure can be performed according to any methods known to a person skilled in the art.

Any suitable photoinitiators can be used in the ink formulations. The photoinitiator presently preferred by the inventors is Irgacure 2959, Irgacure 907, Irgacure 500, Irgacure 651, Irgacure 369, Darocure 1173, or Darocure 4265. In addition, combinations of initiators can be used.

It is discovered that, in a print-on-mold process involving a water-based ink for producing colored contact lenses, removing of the ink solvent by evaporation does not prevent the printed colored image on the molding surface from being distorted once a lens-forming material is dispensed in the mold with the printed colored image. This distortion of a colored image on a molding surface of mold resulted from dispensing a lens-forming material thereon is also called smearing or color smearing. Such smearing can be detrimental to the final product (colored contact lenses) since the resulting colored images on lenses are distorted. By UV-curing to a certain extent of a water-based ink of the invention on a molding surface of a mold before dispensing a lens-forming material, one can substantially reduce ink smearing effects in resultant products. Since a colorant (e.g., a pigment) can have adversely impacts on UV radiation intensity required for curing the ink at a given UV irradiation time, a relatively high UV radiation energy exposure may be required to cure an ink. This problems can be solved by adding a photoinitiator in a water-based ink to reduce energy exposure required for curing an ink. An ink can be partially or entirely cured to an extent so that no smearing will occur. Advantage of partially curing of an ink is that residual (uncrosslinked) ethylenically unsaturated groups can participate in crosslinking reaction of a lens-forming material and as such the colored film can be covalently attached to the resultant lens.

In accordance with the invention, the ink comprises preferably from about 0.4% to about 2.4% by weight, more preferably from about 0.55% to about 2.1% by weight, even more preferably from about 0.7% to about 1.5% by weight of a photoinitiator. It is found from ink curing studies with varying concentrations of a photoinitiator that the initiator concentration affects the amount of UV exposure required to cure the ink.

The inks of the invention can optionally include one or more vinylic monomers or macromers.

The inks of the invention can also optionally (but preferably do not) include one or more members selected from the group consisting of a crosslinker, an antimicrobial agent, a humectant, an antioxidant agent, an anti-coagulating agent, and other additives known in the art.

A “cross linker” refers to a compound comprising two or more functional groups, as they are known in the art. A cross linker molecule can be used to crosslink two or more monomers or polymer molecules. Cross linkers are known in the art and are disclosed in various US patents. Such crosslinkers may be added to the ink in order to match the physical properties (e.g. modulus) of the cured ink to that of the cured lens to which it is applied.

The viscosity of an ink for pad-transfer printing is also important for maintaining print quality. The viscosity is preferably above 100 cps; more preferably above 200 cps, even more preferably above 350 cps. The viscosity of an ink solution can be as high as about 5,000 centipoise (cps), but is preferably between about 900 to about 3500 cps.

The proper concentration of binder polymer and the colorant in water to achieve the preferred ink viscosity can be determined, for example, by a design of experiment by modeling the design as a quadratic D-optimal mixture design. This can be done, for example, with a commercial software program, such as Design Expert (v. 6.0.0, from Stat-Ease of Minneapolis, Minn.), according to a similar procedure described in U.S. patent application Publication No. 2004/0044099A1.

In a preferred embodiment, an ink of the invention comprises: water in an amount of from about 30% to 98% by weight, preferably from about 50% to 93% by weight; a water-soluble and actinically-curable binder polymer in an amount of from about 2% to 40% by weight, preferably about 6% to 30%; and a colorant in an amount of from about 0.5% to 30% by weight, preferably about 1.5% to 20%; a rapid diffusive surfactant (preferably an acetylenic diol-based surfactant, more preferably Surfynol® 420 surfactant) in an amount of from about 0.03% to about 0.20% by weight; and a photoinitiator in an amount of from about 0.4% to about 2.4% by weight, more preferably from about 0.55% to about 2.1% by weight, even more preferably from about 0.7% to about 1.5% by weight.

Lens molds for making contact lenses are well known to a person skilled in the art and, for example, are employed in cast molding or spin casting. For example, a mold (for cast molding) generally comprises at least two mold sections (or portions) or mold halves, i.e. first and second mold halves. The first mold half defines a first molding (or optical) surface and the second mold half defines a second molding (or optical) surface. The first and second mold halves are configured to receive each other such that a lens forming cavity is formed between the first molding surface and the second molding surface. The molding surface of a mold half is the cavity-forming surface of the mold and in direct contact with lens-forming material.

Methods of manufacturing mold sections for cast-molding a contact lens are generally well known to those of ordinary skill in the art. The process of the present invention is not limited to any particular method of forming a mold. In fact, any method of forming a mold can be used in the present invention. The first and second mold halves can be formed through various techniques, such as injection molding or lathing. Examples of suitable processes for forming the mold halves are disclosed in U.S. Pat. No. 4,444,711 to Schad; U.S. Pat. No. 4,460,534 to Boehm et al.; U.S. Pat. No. 5,843,346 to Morrill; and U.S. Pat. No. 5,894,002 to Boneberger et al., which are also incorporated herein by reference.

Virtually all materials known in the art for making molds can be used to make molds for making contact lenses. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, N.J.), or the like can be used. Other materials that allow UV light transmission could be used, such as quartz glass and sapphire.

Pad transfer printing is well known in the art (see. For example, U.S. Pat. No. 3,536,386 to Spivack; U.S. Pat. Nos. 4,582,402 and 4,704,017 to Knapp; U.S. Pat. No. 5,034,166 to Rawlings et al., herein incorporated by reference in their entireties). A typical example of this printing follows. An image is etched into metal to form a cliché. The cliché is placed in a printer. Once in the printer, the cliché is inked by either an open inkwell doctoring system or by a closed ink cup sliding across the image. Then, a silicone pad picks up the inked image from the cliché and transfers the image to the contact lens. The silicone pads are made of a material comprising silicone that can vary in elasticity. The properties of the silicone material permit the inks to stick to the pad temporarily and fully release from the pad when it contacts a contact lens or a mold. Appropriate pad-transfer printing structures include, but are not limited to, Tampo-type printing structures (Tampo vario 90/130), rubber stamps, thimbles, doctor's blade, direct printing, or transfer printing as they are known in the art.

Any known suitable silicone pad can be used in the present invention. Silicone pads are commercially available. However, different pads could give different print qualities. A person skilled in the art will know how to select a pad for a given ink.

Clichés can be made of ceramics or metals (e.g., steel). Where a cliché is made of a steel, it would be desirable to neutralize the pH of a water-based ink (e.g., adjusted pH to 6.8 ˜ 7.8) by adding a buffer (such as, for example, phosphate salts). Images can be etched into a cliché according to any methods known to a person skilled in the art, for example, by chemical etching or laser ablation or the like. It is also desirable to clean clichés after use using standard cleaning techniques known to a person skilled in the art, such as, for example, immersion in a solvent, sonication, or mechanical abrasion.

It is discovered that print quality can be affected adversely by duration of “hang-time”, or the time between picking up inks from a cliché and dropping the ink off on a mold, as described in a copending patent application. Image quality begins to degrade when the “hang-time” is increased to 30-seconds. Blowing dry air (0% relative humidity) on pads for 15 seconds prior to transferring inks from the pads to molds could dramatically worsen the print quality. Blowing the 100% relative humidity air on pads may not affect the print quality, despite 15 second “hang-time.” Blowing the 100% relative humidity air on pads could extend the print quality to 30 seconds. Selectively blowing humidified air on the pads or creating a blanket of humid air on a pad could prolong “hang-time” and/or improve the print quality. The humidified air can be created either by using a laboratory bubbler (as an initial test), or by using industrial humidifiers designed to connect to duct work (see http://www.ishumidifiers.com/elmc.htm). The humid air could either be directional or diffuse, depending upon the configuration of a pad transfer printer to be used.

In accordance with the invention, an ink of the invention can be applied on the molding surface of one or both mold portions by using pad transfer printing (or pad printing) to form a colored coat (with a color image). A colored coat can be applied on the molding surface defining the posterior (concave) surface of a contact lens or on the molding surface defining the anterior surface of a contact lens or on both mold portions. Preferably, a colored coat (with a color image) is applied on the molding surface defining the anterior surface of a contact lens. However, there are special cosmetic effects achievable by providing a pattern on both the anterior and posterior surfaces of a contact lens. For instance, a colored pattern of one color can be applied to the molding surface defining the back surface of the lens (for instance, white) and the same or different colored pattern can be applied to the molding surface defining the front surface of the lens (for instance, dark blue). This then would result in a lens that could have either a multi-color textured appearance for extremely lifelike appearance, or a brighter tint using a white background to reflect back out at the observer.

If the lens is intended to be natural in appearance, the pattern applied to the lens preferably contains voids. Examples of such patterns are disclosed in U.S. Pat. No. 5,160,463 to Evans et al. and U.S. Pat. No. 5,414,477 to Jahnke (herein incorporated by reference in their entireties). Typically the voids comprise about 5 to about 80% of the pattern's area. On the other hand, it is preferred that the pattern occupy from 50% to all of the area of the lens in the iris region thereof (or that portion of the molding surface corresponding to the iris region of the lens). If the colorant is opaque, then only the portion of the lens corresponding to the iris is usually printed, leaving the pupil section clear or tinted. For lenses that are larger in diameter than the iris, the portion of the lens extending beyond the iris may be left unprinted. A person skilled in the art will know well how to design color patterns.

Optionally, a transferable coating can be applied to a molding surface of a mold before applying the ink by pad transfer printing. A transfer coating is intended to describe a coating which can be detached from a molding surface of a mold and become integral with the body of a contact lens molded in the mold. A transferable coating can be applied to a molding surface of mold by any suitable techniques, such as, for example, spraying, printing, swabbing, or dipping. A transferable coating can be prepared from a solution comprising polymerizable components. For example, a transferable coating with substantially uniform thickness (less than 200 microns) can be prepared by spraying a molding surface with a solution having the composition (without colorant) of an ink to be used or a solution of prepolymer or a lens-forming material to be used. This transferable coating can optionally be cured to form a transferable clear film (without any pigment but optionally with dyes including reactive dyes). One or more colored patterns can then be printed on this transferable coating or film. By applying a transferable coating before printing, one can make a colored lens in which printed colored patterns are imbedded just below a film derived from the transferable coating. Such lens may be more comfortable for wearing and have much less susceptibility to colorant leaching out of the colored lens.

After printing an ink of the invention on a molding surface of a mold, the printed ink can be cured by UV or other actinic radiation to form a colored film in accordance with the invention. It is desirable that the printed ink is cured actinically to an extent to minimize loss of pattern definition of the colored coat resulted from subsequent filling of a lens-forming material.

Any lens-forming materials can be used in the invention and is not presently considered a critical part of this aspect of the invention. Lens forming materials that are suitable in the fabrication of contact lenses are illustrated by numerous issued US patents and familiar to those skilled in the art. Preferred lens-forming materials are capable of forming hydrogels. A lens-forming material can comprise one or more prepolymers, optionally one or more vinylic monomers and/or macromers and optionally further include various components, such as photoinitiator, visibility tinting agent, fillers, and the like. It should be understood that any silicone-containing prepolymers or any silicone-free prepolymers can be used in the present invention. While the selection of a lens-forming material is largely determined upon the final modality of use of the final contact lens, the presently preferred lens material is nelfilcon. Nelfilcon contact lenses are available commercially from CIBA Vision of Duluth, Ga.

A preferred group of lens-forming materials are prepolymers which are water-soluble and/or meltable as described above. It would be advantageous that a lens-forming material comprises primarily one or more prepolymers which are preferably in a substantially pure form (e.g., purified by ultrafiltration). Therefore, after crosslinking/polymerizing by actinic radiation, a contact lens may require practically no more subsequent purification, such as complicated extraction of unpolymerized constituents. Furthermore, crosslinking/polymerizing may take place solvent-free or in aqueous solution, so that a subsequent solvent exchange or the hydration step is not necessary.

A person skilled in the art will known well how to actinically or thermally cure the lens-forming material within the lens-forming cavity to form the contact lens.

In a preferred embodiment, where a lens-forming material is a solution, solvent-free liquid, or melt of one or more prepolymers optionally in presence of other components, reusable molds are used and the lens-forming material is cured actinically under a spatial limitation of actinic radiation to form a colored contact lens. Examples of preferred reusable molds are those disclosed in U.S. patent application Ser. No. 08/274,942 filed Jul. 14, 1994, Ser. No. 10/732,566 filed Dec. 10, 2003, Ser. No. 10/721,913 filed Nov. 25, 2003, and U.S. Pat. No. 6,627,124, which are incorporated by reference in their entireties.

In this case, the lens-forming material is put into a mold consisting of two mold halves, the two mold halves not touching each other but having a thin gap of annular design arranged between them. The gap is connected to the mold cavity, so that excess lens material can flow away into the gap. Instead of polypropylene molds that can be used only once, it is possible for reusable quartz, glass, sapphire molds to be used, since, following the production of a lens, these molds can be cleaned rapidly and effectively off the uncrosslinked prepolymer and other residues, using water or a suitable solvent, and can be dried with air. Reusable molds can also be made of Topas® COC grade 8007-S10 (clear amorphous copolymer of ethylene and norbornene) from Ticona GmbH of Frankfurt, Germany and Summit, N.J. Because of the reusability of the mold halves, a relatively high outlay can be expended at the time of their production in order to obtain molds of extremely high precision and reproducibility. Since the mold halves do not touch each other in the region of the lens to be produced, i.e. the cavity or actual mold faces, damage as a result of contact is ruled out. This ensures a high service life of the molds, which, in particular, also ensures high reproducibility of the contact lenses to be produced.

The two opposite surfaces (anterior surface and posterior surface) of a contact lens are defined by the two molding surfaces while the edge is defined by the spatial limitation of actinic irradiation rather than by means of mold walls. Typically, only the lens-forming material within a region bound by the two molding surfaces and the projection of the well defined peripheral boundary of the spatial limitation is crosslinked whereas any lens-forming material outside of and immediately around the peripheral boundary of the spatial limitation is not crosslinked, and thereby the edge of the contact lens should be smooth and precise duplication of the dimension and geometry of the spatial limitation of actinic radiation. Such method of making contact lenses are described in U.S. patent application Ser. Nos. 08/274,942 filed Jul. 14, 1994, Ser. No. 10/732,566 filed Dec. 10, 2003, Ser. No. 10/721,913 filed Nov. 25, 2003, and U.S. Pat. No. 6,627,124, which are incorporated by reference in their entireties.

A spatial limitation of actinic radiation (or the spatial restriction of energy impingement) can be effected by masking for a mold that is at least partially impermeable to the particular form of energy used, as illustrated in U.S. patent application Ser. Nos. 08/274,942 filed Jul. 14, 1994 and U.S. Pat. No. 6,627,124 (herein incorporated by reference in their entireties) or by a mold that is highly permeable, at least at one side, to the energy form causing the crosslinking and that has mold parts being impermeable or of poor permeability to the energy, as illustrated in U.S. patent application Ser. No. 10/732,566 filed Dec. 10, 2003, Ser. No. 10/721,913 filed Nov. 25, 2003 and U.S. Pat. No. 6,627,124 (herein incorporated by reference in their entireties). The energy used for the crosslinking is radiation energy, especially UV radiation, gamma radiation, electron radiation or thermal radiation, the radiation energy preferably being in the form of a substantially parallel beam in order on the one hand to achieve good restriction and on the other hand efficient use of the energy.

It should be understood that an ink of the invention should have a good transferability of the colored coat from a mold to a contact lens and a good adhesion to the molded lens. By actinically or thermally curing the lens-forming material within the lens-forming cavity, the colored film detaches from the molding surface and becomes integral with the body of the resultant contact lens, wherein the colored film becomes part of one of the anterior and posterior surface of the colored contact lens and has a good adhesion to the lens. The resultant colored contact lens is essentially smooth and continuous on the surface containing the color film.

The good transferability and adhesion may be resulted largely from interpenetrating network formation during curing of the lens-forming material in the mold. Without limiting this invention to any particular mechanism or theory, it is believed that the ink binders of the invention can form interpenatrating networks (IPN's) with the lens material of a hydrogel lens. Adhesion of an ink of the invention to the lens by IPN formation does not require the presence of reactive funtional groups in the lens polymer. The lens-forming material is crosslinked in the presence of crosslinked binder polymer in the colored film to form IPNs. It is understood that some (residual) ethylenically unsaturated groups in the binder polymer may not be consumed during curing of the colored coat to form the colored film. These residual ethylenically unsaturated groups may undergo crosslinking reaction to bind the binder polymer to the lens material during the curing of the lens-forming material in the mold.

It is also understood that adhesion between lenses and ink could be enhanced by direct linkage (bond formation) between binder polymer and lens polymer. For example, a binder polymer containing nucleophilic groups could undergo reactions with lens polymer that contains electrophilic groups such as epoxy, anhydride, alkyl halide and isocyanate. Alternatively one could bind ink to lenses by having electrophilic groups in the ink binder polymer and nucleophic groups in the lens polymer. Curable inks could also be made be incorporating both nucleophilic and electrophilic functionality into to binder polymer.

The invention provides methods for enhancing the quality and resolution of a colored image on a contact lens obtained through a print-on-mold process. By adding a rapid diffusive surfactant into a water-based ink to lower the surface tension of the ink to less than about 40 dyne/cm at surface age of about 1 second, one can minimizing or prevent ink drops in an inked image picked up by a silicone pad from pooling on the silicone pad and thereby preserve image quality and resolution. By adding an initiator in a water-based ink in an amount sufficient to allow the ink to be cured with an energy exposure which is comparable with an energy exposure required for curing the lens-forming material, one can cure a colored coat printed on a molding surface of a mold in a substantially uniform manner to form a colored film before dispensing a lens forming material into the mold, so that not only color smearing but also built-in stresses in a resultant colored contact lens can be minimized or eliminated.

The previous disclosure will enable one having ordinary skill in the art to practice the invention. In order to better enable the reader to understand specific embodiments and the advantages thereof, reference to the following examples is suggested. The percentages in the formulations are based on weight percentages unless otherwise specified.

### EXAMPLE 1

Two black ink are prepared to have the compositions shown in Table 1.

TABLE 1

| | Composition | | |
|---|---|---|---|
| Ink | Nelfilcon¹ | Black iron oxide | Surfynol ® 420 surfactant |
| B1 | 86.16% | 13.84% | 0 |
| B2 | 86.01% | 13.84% | 0.15% |

¹An aqueous solution of nelfilcon (30% by weight of nelfilcon and 70% by weight of water). Nelfilcon is an acrylated- poly(vinyl alchohol).

Each ink (B1 or B2) is used to print (by pad transfer printing) a black outer starburst pattern (similar to that in FIG. 4) onto a portion of the molding surface of a mold, the portion of the molding surface corresponding to the iris region of a colored contact lens. FIGS. 1a-1b show the images of black inks picked up by conical silicone pad from a cliché. In the absence of Surfynol® 420 surfactant, the patterns of the colored image is distorted or lost due to pooling of ink drops on the silicone pad. In the presence of 0.15% of Surfynol® 420 surfactant in a water-based ink, no pooling of ink drops is observed on the silicone pad and the patterns and resolution of the colored image are substantially preserved.

### EXAMPLE 2

Five different green inks are prepared to have varying initiator (Irgacure 2959) and surfactant (Surfynol® 420) concentration as shown in Table 2. The percentage of each components is by weight.

TABLE 2

| | Composition | | | |
|---|---|---|---|---|
| | | chromium | | Irgacure ® |
| Ink | Nelfilcon¹ | oxide | Surfactant² | 2959 |
| 1558-85-1 | 83.24% | 16.09% | 0.048% | 0.71% |
| 1558-85-2 | 82.49% | 16.09% | 0.094% | 1.40% |
| 1558-85-3 | 81.74% | 16.09% | 0.148% | 2.10% |
| 1558-85-4 | 83.14% | 16.09% | 0.151% | 0.70% |
| 1558-85-5 | 81.84% | 16.08% | 0.050% | 2.11% |

¹An aqueous solution of nelfilcon (30% by weight of nelfilcon and 70% by weight of water)
²Surfynol ® 420 surfactant

These inks are used to print on the glass female mold halves of reusable molds shown in FIGS. 1-9 of U.S. Pat. No. 6,627,124 according to pad transfer printing technique. The male mold halves are made of quartz. The inks are cured under a Hamamatsu lamp with a fiber optic probe. No cut-off filter is used. The light is passed through a condenser (f=22.5 mm), with a distance 40 mm from the condenser to the mold. UVB light between 5.09 and 6.84 mW/cm² is used for 2 seconds, as measured by a Groebel detector. The intensity is monitored by measuring the aperture of the Hamamatsu lamp. Only after a neutral density (density=2.0, 1% transmission) filter, it is found that the power needed to cure the 1558-85-1 ink is between 20 and 28 mW/cm²

It is noted that when using different power detectors (e.g., such as a ESE sensor or a Groebel detector), different values of radiation power from a single UV radiation source can be found.

After curing the printed ink on female mold halves, a nelfilcon solution containing about 30% nelfilcon and 0.1% Irgacure 2959 is dispensed onto the printed female mold halves by using an EFD automatic dispenser (4 bar, 1.2 sec). The female mold halves are allowed to sit for 10 seconds before mating then with corresponding male mold halves and closing molds by using a pneumatic closing system. The nelfilcon is UV cured with a Dr. Groebel lamp, with a 305 nm (50% transmission) cut-off filter installed in the condenser. The molds are opened and resultant colored contact lenses are stored in DI water until use.

Colored contact lenses are examined by imaging under back-lighting conditions to emphasize contrast. Imaging is performed using a parafocal zoom lens (0.7×-4.5×, VZM-450, Edmund Scientific) with a 0.5× supplemental lens. A Sony XC-999 camera connected to a Matrox Meteor 2 frame grabber allowed images to be taken with Archive4Images (A4I) software (Aquinto). The A4A software automatically exports the images to Microsoft Word, which can examined for print quality and resolution.

After curing these inks with UV radiation of 5-7 mW/cm², the lenses are made and inspected for color smearing. Only at the high initiator level (2.1%) no color smearing is observed while at the middle and low initiator levels, signs of color smearing are observed.

The light intensity is varied with a low initiator ink formulation (formulation 1558-58-1, 0.7% initiator) to determine if more light could cure the ink. Color smearing seems to be minimized when curing UV radiation of 20-28 mW/cm² (between 11 and 12% aperture). Potentially all ink in this initiator range could be cured if the intensity are set above 30 mW/cm².

Lenses made with all Surfynol® levels showed good transfer of the ink from the pad to the mold. It is observed that low Surfynol® levels seems to correspond with an increase in color intensity. This could be due to less spreading of the ink on the silicone pad, but not enough to cause pooling.

### EXAMPLE 3

The following samples are prepared for static (equilibrium) surface tension measurements.
CB Green Ink. An organic solvent-based green ink (CB Green Ink) is prepared by mixing 26.7% by weight of an activation solution (containing 15.42% by weight of HDI (1,6 hexamethylene diisocyanate); 75.7% by weight of HEMA (hydroxyethylmethacrylate); 8.45% EOEMA (2-ethyoxyethyl methacrylate); and 0.43% Vazo-64) with a green paste (containing 0.03% by weight of phthalocyanine (PCN) blue; 7.59% by weight of chromium oxide; 28.53% by weight of ethyl lactate; 63.85% by weight of a binder). The binder is prepared by partial polymerization of a composition comprising 38.42% by weight of HEMA; 4.2% by weight of EOEMA; 56.93% by weight of Cyclopentanone; 0.23% by weight of 2-mercaptoethanol; 0.21% by weight of Vazo-64; and 0.01% by weight of MEHQ (methylether hydroquinone) according to the procedures described in U.S. Pat. No. 4,668,240 to Loshaek (herein incorporated by reference in its entirety).
Ink 1574-88-1. This ink is prepared by mixing 9.68% Chromium Oxide, 1.00% irgacure, 89.32% nelfilcon solution (30% by weight of nelfilcon and 70% by weight of water)
Ink 1558-85-1. Prepared in Example 2.
Ink 1558-85-3. Prepared in Example 2.
Nelfilcon 1. This aqueous solution contains 30% by weight of nelfilcon and 50 ppm TEMPO (4-hydroxy-2,2,6,6,-tetramethyl-1-piperidinyloxy, free radical) (CAS# 2226-96-2).
Nelfilcon 2. This aqueous solution contains 30% by weight of nelfilcon and 0.3% by weight of poloxamer 108.

The static (equilibrium) surface tensions of inks and solutions are determined by DuNouy ring method or the Wilhelmy plate method. Results are shown in Table 3. The surface tension of water as measured by the DuNouy ring method is 72.8 dynes/cm (or mN/m).

TABLE 3

| | Samples | | | | | |
|---|---|---|---|---|---|---|
| | CB Green | Nelfilcon 1 | Nelfilcon 2 | 1574-88-1 | 1558-85-1 | 1558-85-3 |
| Surface tension | 33.2 | 44.6 | 40.3 | 44.8 | 32.2 | 31.3 |
| (mN/m) | | | | | | |

### EXAMPLE 4

The non-equilibrium surface tensions of two inks (1558-88-1 and 1558-85-3) are determined by the pendant drop technique. The pendant drop technique works as follows.

A drop (having a volume of 4.0 microliters) of an ink is formed over a period of 1.0 second on the end of a downward-pointing capillary tip (i.e., a needle with a 1.82 mm O.D., 1.52 mm I.D.). The drop is typically formed to about 90% of its detachment volume (from the capillary). The drop is then digitally imaged as function of time (in real time) and 300 points (150 pairs of two vertically separate points) along the drop surface in each images (in real time) are used to determine the mean curvature of the drop at a specific time. From one drop image, surface tension is determined at least 150 times. These surface tension values are averaged to give a single value for the overall surface tension of the drop at a specific time.

According to Laplace's equation, the pressure difference at any given point on a curved surface (ΔP) is proportional to mean curvature of the surface at that point ((1/r₁+1/r₂), as defined by the following equation
ΔP=(1/r₁+1/r₂) 2 σ
in which r₁ and r₂ are the principal radii of curvature and σ is the surface tension. For a pendant drop, the pressure difference within the drop between any two vertical positions (A and B) is:
ΔP_{A}−ΔP_{B}=Δρ g Z
where Δρ=the difference in density between the liquid that is forming the drop and the bulk gas, g=gravity, and Z=the vertical distance between the two positions (A and B). Combination of above equations yields the following equation for calculating surface tension.
((1/r₁+1/r₂)_{at A}31 (1/r₁+1/r₂)_{at B}) 2 σ=Δρ g Z

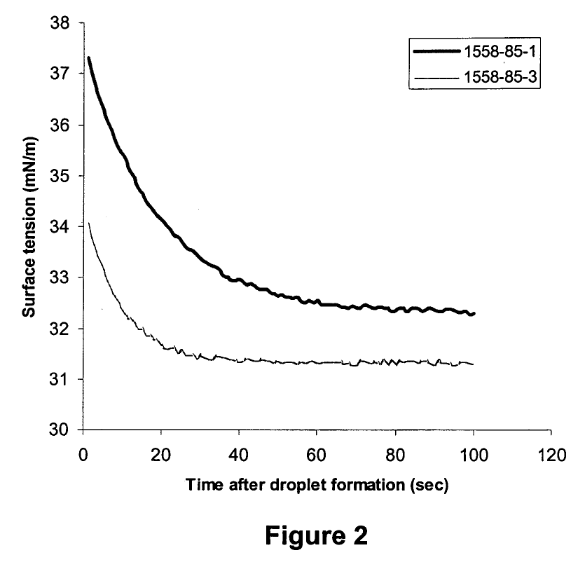

For each ink, two separate tests are performed, i.e., monitoring two individual pendant drops as function of time. The results are reported in FIG. 2.

It can notice from FIG. 2 that the equilibrium surface tension of the 1558-85-3 ink is lower than that of the 1558-85-1 ink sample, but they also show that the time frame in which the equilibrium surface tension is approached is much shorter for the 1558-85-3 ink sample (about 30 seconds in the case of 1558-85-3, versus about 60 seconds in the case of 1558-85-1). Also, the measurable surface tension range is much larger for the 1558-85-1 sample—about 5.0 mN/m from 1.0 second to equilibrium. For 1558-85-3, the surface tension range is only about 2.7 mN/m from 1.0 second to equilibrium.

### EXAMPLE 5

A variety of black and green inks are prepared by combing the nelfilcon solution (30% nelfilcon, 0.3% poloxamer, 50 ppm HTMPO, and water), Surfynol® 420, and Irgacure® 2959 with one of two pigments: chromium oxide (C.O.) and black iron oxide (B.I.O.). The compositions of each ink is shown in Table 5 (all of the percentages are by weight).

TABLE 5

| Ink No. | Nelfilcon % | B.I.O. % | C.O. % | Surfynol ® 420% | Irgacure ® 2959% |
|---|---|---|---|---|---|
| 1558-74-1 | 86.16 | 13.84 | | | 0.09 |
| 1558-74-3 | 80.95 | | 19.05 | | 0.08 |
| 1558-74-7 | 86.01 | 13.84 | | 0.15 | 0.09 |
| 1558-74-9 | 80.80 | | 19.05 | 0.15 | 0.08 |
| 1574-11B^{#} | 72.75 | | 17.11 | 0.13 | 0.08 |
| 1574-13A | 81.55 | | 16.02 | 0.13 | 2.38 |
| 1574-4 | 80.83* | | 19.02 | 0.15 | 0.08 |
| 1574-8 | 86.01* | 13.83 | | 0.16 | 0.09 |

*prepared from nelfilcon solution which is free of HTMPO.
^{#}Containing 10.01% ethanol.

The above prepared inks are used to produce colored contact lenses according to a print-on-mold process, using a single reusable mold comprising a glass female mold half and a quartz male mold half, based on prints of two patterns “outer starburst” and “Main iris” shown in FIGS. 2-3 of commonly assigned co-pending US patent application Publication No. US 2003/0025873A1 (herein incorporated by reference in its entirety). The “outer starburst” is printed with a black ink and the “main iris” pattern is printed with a green ink. Each of the patterns is etched into either a ceramic or steel cliché. Either a Phoenix or TampoPrint pad is used. The production process comprises printing the molding surface of the female mold half separately with a black ink and a green ink; dosing a nelfilcon solution (as lens-forming material) into the female mold half with printed patterns; closing the mold (i.e., placing the male mold half on top of the female mold half and closing the mold); curing the nelfilcon solution within the mold to form a colored lens; and removing the formed lens from the mold.

It is noted that prints, in particular, the iris pattern print, smear underneath the nelfilcon dosing drop and during the mold closing process. Various experiments have been carried out to determine the causes of smearing. In first series of experiments, inks are allowed to dry on the female mold for 120 seconds prior to the dosing step. This is designed to allow sufficient water to evaporate from the ink to increase its viscosity sufficiently to prevent smearing. This experiment showed ink smearing in the dosing/closing steps. In another experiments, the speed of nelfilcon dosing (on printed mold) is slowed to determine effects of dosing speed on smearing. Results do not show that smearing is eliminated though there is slight reduction in smearing. In another experiments, the nelfilcon solution is dispensed (dosed) in the center of the female mold rather than offsetting it to the side at different dosing quantity (about 25 mg or about 44 mg). Smearing is still observed. In another experiments, inks are allowed to be partially dry on the pad before being printed on the mold. The longest dry time (about 23 seconds) can lessen but not eliminate smearing. Another experiments are done to examine the effects of reducing the relative humidity, speeding up the mold closing process, increasing the amount of nelfilcon being dosed, and adding a volatile solvent (ethanol) to the ink on smearing. Smearing is observed in all experiments.

It is found that smearing can be completely eliminated (or at least substantially reduced) by adding photoinitiator (Irgacure 2959) to the ink and exposing it to sufficient amounts of UV radiation on the mold half prior to dosing. The printing inks also contained surfactant, Surfynol 420, to control ink spreading on both the hydrophobic silicone pad and the hydrophilic glass mold half.

Table 6 shows the results (green iris pattern smearing) of experiments where printed inks on the molding surface of female mold half are irradiated with UV light under various conditions before dosing a nelfilcon solution into the mold. In experiments 1-4, the UV radiation power is about 1.60 mW/cm² determined by Groebel detector. In experiments 7-13, a UV light source with high output power is used and a light guide is used to direct the UV light to irradiate directly the molding surface of the female mold half.

TABLE 6

| Experiment | | UV Exposure | |
|---|---|---|---|
| # | Green Ink | time (s) | Smearing |
| 1 | 1558-74-9 | 4 | ++++ |
| 2 | 1558-74-9 | 8 | ++++ |
| 3 | 1558-74-9 | 30^{a} | ++ |
| 4 | 1574-13A | 8^{a} | + |
| 5 | 1574-13A | 0 | ++++^{b} |
| 6 | 1574-13A | 0 | ++++^{c} |
| 7 | 1574-13A | 30 | − |
| 8 | 1574-13A | 7 | − |
| 9 | 1574-13A | 4 | − |
| 10 | 1574-13A | 15^{d} | − |
| 11 | 1574-13A | 2 | − |
| 12 | 1574-13A | 1 | + |
| 13 | 1574-4 | 15 | +++ |

^{a}under nitrogen purge;
^{b}no UV radiation and 6 minutes delay between printing and dosing steps;
^{c}blow nitrogen onto the mold for 30 seconds prior to dosing;
^{d}UV radiation though the female mold half.

Experiment 4 and its control (experiment 5) show that smearing can be reduced when the ink with the increased amount of Irgacure 2959 is exposed to UV radiation prior to dosing the elimination of smearing is further confirmed in other experiments, e.g., experiments 7-12 where UV radiation exposure of inks printed on the female mold prior to dosing eliminates smearing. Experiment 13 shows that the smearing may occur as the amount of UV radiation energy exposure decreases below a threshold value for a given photoinitiator concentration.

### EXAMPLE 6

A variety of inks are prepared by combining the nelfilcon solution (30% nelfilcon and 70% water), Surfynol® 420, and Irgacure® 2959 with various pigments: 0-3.8% titanium dioxide; 0-2.61% phthalocyanine blue (PCN blue); 0-0.45% phthalocyanine green (PCN green); 0-6% yellow iron oxide; 0-1.84% red iron oxide; 0-12% chromium oxide; 0-13.8% black iron oxide. Each ink comprises 0.05%, 0.1% or 0.15% by weight of Surfynol® 420. Each ink comprises 0.70% or 1.4% by weight of Irgacure® 2959 (photoinitiator). depending upon the color hue, surfactant level, and initiator level desired. For example, a red ink could be made by using the high level of red iron oxide (E) and low levels of the other pigments. The nelfilcon levels are varied from 84.84% to 97.64% by weight to achieve 100% values.

These inks are used to produce colored contact lenses according to a print-on-mold process, using a single reusable mold comprising a glass female mold half and a quartz male mold half, using at least two of three patterns “outer starburst”, “Main iris”, and “inner starburst” shown in FIGS. 2-4 of commonly assigned co-pending US patent application Publication No. US 2003/0025873A1 (herein incorporated by reference in its entirety). The patterns can be printed, one by one, on a molding surface of a mold for making contact lenses. Each of the patterns is etched into either a ceramic or steel cliché. Either a Phoenix or TampoPrint pad is used. After printing, the ink is cured with a Hamamatsu lamp (model L8333) with an installed 297 nm UV cure filter. The light is funneled through a light guide and passed through a condenser (f=16 mm) with a distance around 50 mm from the condenser to the mold. The condenser is mounted at a slight angle (˜30° from vertical), with respect to the molding surface, to allow the printing to occur unencumbered. The light intensity is controlled by adjusting the aperture of the Hamamatsu lamp and measured with a Dr. Gröbel hand-held UVB monitor.

After curing the printed ink on the female mold half, a nelfilcon solution containing about 30% nelfilcon and 0.1% Irgacure 2959 is dispensed onto the printed female mold half by using an EFD automatic dispenser (4 bar, 1.2 sec). The female mold halves are allowed to sit for several seconds before mating them with corresponding male mold halves and closing molds by using a pneumatic closing system. The nelfilcon is UV cured under 2 different UV lights (1.8 mW/cm² each) for total exposure time of 4.9 sec.

Clear controls (contact lenses without printed images) are made simultaneously with another mold of the same type.

All lenses are subjected to conventional steam autoclave.

Experiments show that initiator concentration affects the amount of UV radiation needed to cure the ink. When the initiator concentration increases from 0.7 to 1.4%, the intensity of UV radiation required for curing ink can be reduced by about 57% while still minimize color smearing. The intensity of UV radiation required for curing ink seems to be independent of pigment color or loading (in the concentration range used). This indicates that a single UV radiation intensity can be used, despite the different colors to be printed, for a given initiator concentration. It is desirable that the initiator concentration can be set at 0.9±0.2% and a UV dosage about 5.4 mW/cm² is used.

Results indicate that a range of surfactant levels (0.05-0.15%) could be used without dramatically affecting the print quality of the color images, as observed by eye and by microscopy.

Some curling of the lenses are observed in resultant colored contact lenses produced in a process where relatively high UV radiation power is used to cure inks on molds. The curling seems to be exacerbated by dosing the UV curing light at an angle related to central axis of the mold. Possibly a gradient curing of the ink could cause built-in stresses that cause the hydrated lens to curl. A UV radiation with a substantially uniform distribution of energy is preferably used to cure the ink printed on a molding surface of a mold.

Mechanical analysis of the colored lenses and control lenses shows that the colored lenses are at least statistically equal to the control lenses. Resultant colored lenses pass cell growth inhibition (CGI) tests. After storing for more than three months at room temperature, colored lenses pass adhesion tests.

Although various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part. Therefore, the spirit and scope of the appended claims should not be limited to the description of the preferred versions contained therein.

What is claimed is:

1. A method for making colored contact lenses, comprising the steps of:
(a) obtaining a water-based ink,
the ink having a viscosity of greater than about 100 centipoise (cps), and
the ink comprising at least one colorant, a water-soluble binder polymer having ethylenically unsaturated groups, an initiator, and a surfactant,
wherein the surfactant is present in the ink in an amount sufficient to provide the ink a dynamic surface tension of less than about 40 mN/m at surface age of about 1 second;
(b) applying the ink, by using pad transfer printing technique, to at least a portion of at least one of molding surfaces of a lens mold to form a colored coat;
(c) actinically or thermally curing the ink printed on the mold to form a colored film, wherein the printed ink is cured to an extent so that no noticeable color smearing is observed by examination with naked eyes;
(d) dispensing a lens-forming material into the lens-forming cavity of the mold; and
(e) actinically or thermally curing the lens-forming material within the lens-forming cavity to form a colored contact lens, whereby the colored film detaches from the molding surface and becomes integral with the body of the contact lens, wherein the colored film becomes part of one of the anterior and posterior surface of the colored contact lens and has a good adhesion to the lens.

2. The method of claim 1, wherein the initiator is present in an amount sufficient to allow the ink to be cured with an energy exposure which is comparable with an energy exposure required for curing the lens-forming material.

3. The method of claim 2, wherein the energy exposure required for curing the ink is about 0.2 to 5 folds of an energy exposure required for curing the lens-forming material.

4. The method of claim 1, wherein the surfactant comprises acetylenic diol-based surfactants.

5. The method of claim 4, wherein the surfactant comprises Surfynol® 420 surfactant (ethoxylated acetylenic diols).

6. The method of claim 5, wherein the amount of surfactant is from about 0.03% to about 0.16% by weight.

7. The method of claim 1, wherein the initiator is a photoinitiator and the amount of the photoinitiator is from about 0.4% to about 2.4% by weight.

8. The method of claim 1, wherein the energy exposure required for curing the ink is about 0.5 to 2 folds of an energy exposure required for curing the lens-forming material.

9. The method of claim 1, wherein the viscosity of the ink is from about 900 to about 3500 cps.

10. The method of claim 1, wherein the binder polymer is a water-soluble, actinically crosslinkable prepolymer selected from the group consisting of: a water-soluble crosslinkable poly(vinyl alcohol) prepolymer; a water-soluble vinyl group-terminated polyurethane; derivatives of a polyvinyl alcohol, polyethyleneimine or polyvinylamine; a water-soluble crosslinkable polyurea prepolymer; crosslinkable polyacrylamide; crosslinkable statistical copolymers of vinyl lactam, methyl methacrylate and a comonomer; crosslinkable copolymers of vinyl lactam, vinyl acetate and vinyl alcohol; polyether-polyester copolymers with crosslinkable side chains; branched polyalkylene glycol-urethane prepolymers; polyalkylene glycol-tetra(meth)acrylate prepolymers; crosslinkable polyallylamine gluconolactone prepolymers, and mixtures thereof.

11. The method of claim 10, wherein the water-soluble, actinically crosslinkable prepolymer is one of polymerizable components in the lens-forming material.

12. The method of claim 10, wherein binder polymer is a polyhydroxyl compound having a molecular weight of at least about 2000 and comprising from about 0.5 to about 80%, based on the number of hydroxyl groups in the poly(vinyl alcohol), of units of the formula I, I and II, I and III, or I and II and III 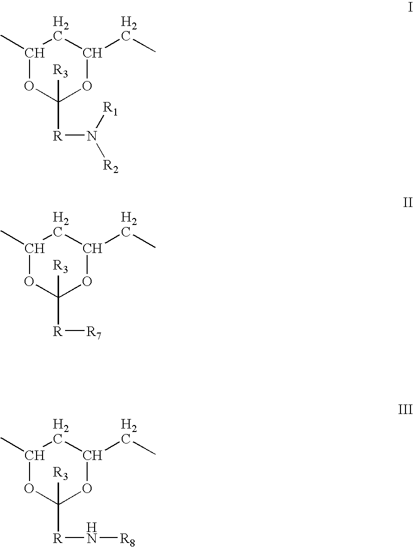
in which
the molecular weight refers to a weight average molecular weight, Mw, determined by gel permeation chromatography,
R is linear or branched alkylene having up to 12 carbon atoms,
R₁ is hydrogen or lower alkyl having up to seven,
R₂ is an ethylefinically unsaturated, electron-withdrawing, crosslinkable radical having up to 25 carbon atoms,
R₃ is hydrogen, a C₁-C₆ alkyl group or a cycloalkyl group,
R₇ is a primary, secondary, tertiary amino group, or a quaternary amino group of the formula N⁺(R′)₃X⁻, in which each R′, independently of the others, is hydrogen or a C₁-C₄ alkyl radical and X is a counterion,
R₈ is the radical of a monobasic, dibasic or tribasic, saturated or unsaturated, aliphatic or aromatic organic acid or sulfonic acid.

13. The method of claim 10, wherein the binder polymer is a water-soluble, crosslinkable polyurea prepolymer of formula (1)
CP-(Q)_{q} (1)
wherein q is an integer of ≧3, Q is an organic radical that comprises at least one ethylenically unsaturated group, CP is a multivalent branched copolymer fragment comprising segments A and U and optionally segments B and T, wherein: A is a bivalent radical of formula
—NR_{A}-A₁-NR_{A}′— (2),
wherein A₁ is the bivalent radical of —(R₁₁—O)ₙ—(R₁₂O)ₘ—(R₁₃—O)ₚ—, a linear or branched C₂-C₂₄ aliphatic bivalent radical, a C₅-C₂₄ cycloaliphatic or aliphatic-cycloaliphatic bivalent radical, or a C₆-C₂₄ aromatic or araliphatic bivalent radical, R₁₁, R₁₂, R₁₃, independently of one other, are each linear or branched C₂-C₄-alkylene or hydroxy-substituted C₂-C₈ alkylene radical, n, m and p, independently of one another, are each a number from 0 to 100, provided that the sum of (n+m+p) is 5 to 1000, and R_{A} and R_{A}′ independently of each other is hydrogen, an unsubstituted C₁-C₆alkyl, a substituted C₁-C₆alkyl, or a direct, ring-forming bond;
T is a bivalent radical of formula 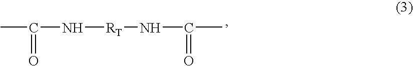
wherein R_{T} is a bivalent aliphatic, cycloaliphatic, aliphatic-cycloaliphatic, aromatic, araliphatic or aliphatic-heterocyclic radical;
U is a trivalent radical of formula 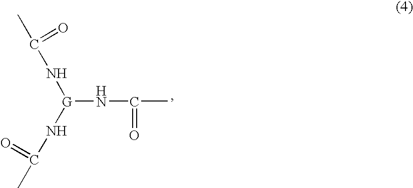
wherein G is a linear or branched C₃-C₂₄ aliphatic trivalent radical, a C₅-C₄₅ cycloaliphatic or aliphatic-cycloaliphatic trivalent radical, or a C₃-C₂₄ aromatic or araliphatic trivalent radical;
B is a radical of formula
—NR_{B}—B₁—NR_{B}′— (5),
wherein R_{B} and R_{B}′ independently of each other is hydrogen, an unsubstituted C₁-C₆alkyl, a substituted C₁-C₆alkyl, or a direct, ring-forming bond, B₁ is a bivalent aliphatic, cycloaliphatic, aliphatic-cycloaliphatic, aromatic or araliphatic hydrocarbon radical that has at least one primary or secondary amine group or is interrupted by at least one amine group —NRₘ— in which Rₘ is hydrogen, a radical Q mentioned above or a radical of formula
Q-CP′— (6),
wherein Q is as defined above, and CP′ is a bivalent copolymer fragment comprising at least two of the above-mentioned segments A, B, T and U; provided that in the copolymer fragments CP and CP′ a segment A or B is followed by a segment T or U in each case; provided that in the copolymer fragments CP and CP′ a segment T or U is followed by a segment A or B in each case; provided that the radical Q in formulae (1) and (6) is bonded to a segment A or B in each case; and provided that the N atom of —NRₘ— is bonded to a segment T or U when Rₘ is a radical of formula (6).

14. The method of claim 1, wherein the ink comprises: water in an amount of from about 30% to about 98% by weight; a water-soluble and actinically-curable binder polymer in an amount of from about 2% to about 40% by weight; a colorant in an amount of from about 0.5% to about 30% by weight; a rapid diffusive surfactant in an amount of from about 0.03% to about 0.20% by weight; and a photoinitiator in an amount of from about 0.4% to about 2.4% by weight.

15. The method of claim 1, wherein the step (c) is performed by using a UV radiation with a substantially uniform distribution of energy.

16. The method of claim 1, wherein the colored coat is applied onto a molding surface defining the anterior surface of a contact lens to be made.

17. The method of claim 15, wherein the UV radiation has an intensity insufficient to cause non-uniform curing of the ink printed on the molding surface.

18. The method of claim 1, wherein a transferable clear coating is applied onto the molding surface of the mold before step (b).

19. The method of claim 18, wherein the transferable coating is prepared from a polymerizable fluid material.

20. A method for making a colored hydrogel contact lens, comprising the steps of:
(a) obtaining a water based ink having a viscosity of greater than about 100 centipoise (cps) and comprising at least one colorant, a water-soluble binder polymer having ethylenically unsaturated groups, an initiator, and a surfactant, wherein the surfactant is present in an amount sufficient to provide the ink a dynamic surface tension of less than about 40 dyne/cm at surface age of about 1 second;
(b) obtaining a mold, wherein the mold has a first mold half with a first molding surface and a second mold half with a second molding surface, wherein said first and second mold halves are configured to receive each other such that the cavity is formed between said first and second molding surfaces;
(c) applying the ink, by using pad transfer printing technique, to at least a portion of at least one of the first and second molding surfaces to form a colored coat;
(d) curing by UV radiation the ink printed on the mold to form a colored film, wherein the printed ink is cured to an extent so that no noticeable color smearing is observed by examination with naked eyes;
(e) dispensing a lens-forming fluid material into the lens-forming cavity of the mold; and
(f) crosslinking and/or polymerizing the lens-forming material under a spatial limitation of actinic radiation to form the contact lens having a first surface, an opposite second surface and an edge, wherein the first surface is defined by the first molding surface, the second surface is defined by the second molding surface, and the edge is defined by the spatial limitation of actinic irradiation, wherein the colored film detaches from the molding surface and becomes part of one of the anterior and posterior surface of the colored contact lens and has a good adhesion to the lens.

21. The method of claim 20, wherein the initiator is present in an amount sufficient to allow the ink to be cured with an energy exposure which is comparable with an energy exposure required for curing the lens-forming material.

22. The method of claim 21, wherein the energy exposure required for curing the ink is about 0.2 to 5 folds of an energy exposure required for curing the lens-forming material.

23. The method of claim 20, wherein the surfactant comprises acetylenic diol-based surfactants.

24. The method of claim 23, wherein the surfactant comprises Surfynol® 420 surfactant (ethoxylated acetylenic diols).

25. The method of claim 24, wherein the amount of surfactant is from about 0.03% to about 0.16% by weight.

26. The method of claim 21, wherein the initiator is a photoinitiator and the amount of the photoinitiator is from about 0.4% to about 2.4% by weight.

27. The method of claim 22, wherein the energy exposure required for curing the ink is about 0.5 to 2 folds of an energy exposure required for curing the lens-forming material.

28. The method of claim 20, wherein the viscosity of the ink is from about 900 to about 3500 cps.

29. The method of claim 20, wherein the binder polymer is a water-soluble, actinically crosslinkable prepolymer selected from the group consisting of: a water-soluble crosslinkable poly(vinyl alcohol) prepolymer; a water-soluble vinyl group-terminated polyurethane; derivatives of a polyvinyl alcohol, polyethyleneimine or polyvinylamine; a water-soluble crosslinkable polyurea prepolymer; crosslinkable polyacrylamide; crosslinkable statistical copolymers of vinyl lactam, MMA and a comonomer; crosslinkable copolymers of vinyl lactam, vinyl acetate and vinyl alcohol; polyether-polyester copolymers with crosslinkable side chains; branched polyalkylene glycol-urethane prepolymers; polyalkylene glycol-tetra(meth)acrylate prepolymers; crosslinkable polyallylamine gluconolactone prepolymers, and mixtures thereof.

30. The method of claim 29, wherein the water-soluble, actinically crosslinkable prepolymer is one of polymerizable components in the lens-forming material.

31. The method of claim 20, wherein the ink comprises: water in an amount of from about 30% to about 98% by weight; a water-soluble and actinically-curable binder polymer in an amount of from about 2% to about 40% by weight; a colorant in an amount of from about 0.5% to about 30% by weight; a rapid diffusive surfactant in an amount of from about 0.03% to about 0.20% by weight; and a photoinitiator in an amount of from about 0.4% to about 2.4% by weight.

32. The method of claim 20, wherein the colored coat is applied onto a molding surface defining the anterior surface of a contact lens to be made.

33. The method of claim 20, wherein the UV radiation has an intensity insufficient to cause non-uniform curing of the ink printed on the molding surface.

34. The method of claim 20, wherein a transferable clear coating is applied onto the molding surface of the mold before step (c).

35. The method of claim 34, wherein the transferable coating is prepared from a polymerizable fluid material.
